(19) United States
(12) Patent Application Publication
(10) Pub. No.: US 2009/0051679 A1
(43) Pub. Date: Feb. 26, 2009

(54) LOCAL MOTION ESTIMATION USING FOUR-CORNER TRANSFORMS

(76) Inventor: Simon Robinson, Collingham (GB)

Correspondence Address: PERKINS COIE LLP;PATENT-SEA, P.O. BOX 1247, SEATTLE, WA, 98111-1247, US

(21) Appl. No.: 11/844,716

(22) Filed: Aug. 24, 2007

(51) Int. Cl. G06F 17/00

(52) U.S. Cl. 345/418

(57) ABSTRACT

A four-corner motion system for precisely modeling local motion is provided. The four-corner motion system provides a motion estimation technique that uses a four-corner transform to describe planar motion. The four-corner motion system produces a motion field that describes the motion of each block in a reference frame at the four-corner level. Thus, the four-corner motion system provides more precise modeling of local motion.

### BACKGROUND

Motion compensation describes an image in terms of where each section of that image came from in a previous image. Motion compensation has a vast range of uses such as in motion picture post-production, machine vision, video compression, motion picture restoration, and deinterlacing. A video sequence consists of a number of images, called frames. Subsequent frames are often very similar, and thus contain a lot of redundancy. Reducing redundancy helps reduce the computational costs associated with the video sequence, such as by reducing bandwidth through achieving better compression ratios.

A simple approach to reducing redundancy is to subtract a reference frame from a given frame. The difference is called a residual and usually contains less information than the original frame. The residual can be encoded at a lower bit-rate with the same quality. The decoder can reconstruct the original frame by adding the reference frame to the residual. A more sophisticated approach to reducing redundancy is to approximate the motion of the whole scene and the objects within a video sequence, a process called motion estimation. The motion is described by parameters that are encoded in the bit-stream. The pixels of the predicted frame are approximated by appropriately translated pixels of the reference frame. This gives much better residuals than a simple subtraction. However, the bit-rate occupied by the parameters of the motion model must not become too large or the benefits are reduced.

In block motion compensation (BMC), the frames are partitioned into blocks of pixels (e.g., macroblocks of 16×16 pixels in MPEG). Each block in a subsequent frame is predicted from a block of equal size in the reference frame. The blocks are not transformed in any way apart from being shifted to the position of the predicted block. A motion vector represents this shift. The motion vector indicates where a subsequent block comes from with relation to a block of the previous frame. The set of motion vectors for each of the blocks in a frame forms a motion field. The motion vectors are the parameters of this motion model and are encoded into the bit-stream.

Motion estimation typically involves finding optimal or near-optimal motion vectors that mathematically describe the motion of each pixel. To find optimal motion vectors, many techniques calculate the block prediction error for each motion vector within a certain search range and pick the one that has the best compromise between the amount of error and the number of bits desired for motion vector data. The amount of prediction error for a block is often measured using the mean squared error (MSE) or sum of absolute differences (SAD) between the predicted and actual pixel values over all pixels of the motion-compensated region.

Current motion estimation methods involve describing the motion as a translational movement of the blocks. For example, the block may move a certain distance up, down, to the left, or to the right. The motion of individual pixels is then chosen from selected blocks. The limitation of this technique is that the blocks are only a translational fit to the motion of the image and thus do not represent more complex local motions such as rotation or shearing. This limitation leads to small errors in the motion field for nontranslational motion and may introduce discontinuities at the block borders (blocking artifacts). These artifacts appear in the form of sharp horizontal and vertical edges that are easily spotted by the human eye and produce ringing effects (large coefficients in high frequency sub-bands) in the Fourier-related transform used for transform coding of the residual frames. The overall result is a video sequence that appears less smooth and realistic to the human eye. A method is needed that increases the precision of the motion field.

### BRIEF DESCRIPTION OF THE DRAWINGS

FIG. 1 illustrates a reference frame and a warp frame in one embodiment.

FIG. 2 is a block diagram that illustrates components of a four-corner motion system in one embodiment.

FIG. 3 is a flow diagram that illustrates the processing performed by a determine transform component in one embodiment.

FIG. 4 illustrates the effect of each of nine transforms on the motion of a pixel in one embodiment.

FIG. 5 illustrates a pyramid of images created by a pyramid optimization process in one embodiment.

FIG. 6 is a flow diagram that illustrates the pyramid optimization performed by a create resolution sets component of the four-corner motion system in one embodiment.

### DETAILED DESCRIPTION

### Overview

A four-corner motion system for precisely modeling local motion is provided. The four-corner motion system provides a motion estimation technique that uses a four-corner transform to describe planar motion. For example, the four-corner motion system allows blocks within a frame to have rotation and shearing components. The four-corner motion system starts with two frames of a video sequence: a reference frame and a warp frame. The four-corner motion system divides the reference frame into blocks. For each block, the four-corner motion system determines a transform that describes the movement of the four corners of the block from their location in the reference frame to their location in the warp frame. For example, the four-corner motion system may determine the transform using a block-based eight-parameter gradient-descent algorithm. After the four-corner motion system has determined a transform for each reference frame block, the four-corner motion system performs a smoothing phase. During the smoothing phase, the four-corner motion system replaces each block's transform with an alternate transform from each of the neighboring blocks. The four-corner motion system determines whether the neighboring transform improves the smoothness of the motion field and, if so, replaces the transform previously assigned to the block with the alternate transform. These steps produce a motion field that describes the motion of each block in the reference frame at the four-corner level. Thus, the four-corner motion system provides more precise modeling of local motion.

The following description is divided into four sections described in further detail. First, the new model including four-corner transforms is described. Next, methods of testing the fit of a particular transform are described. Next, techniques for simplifying the motion field are described. Finally, a pyramid optimization for improving the modeling of large motions is described.

### Four-Corner Model

As discussed above, the four-corner motion system improves the modeling of local motion by using more precise four-corner transforms to describe the motion of each block in a frame of video.

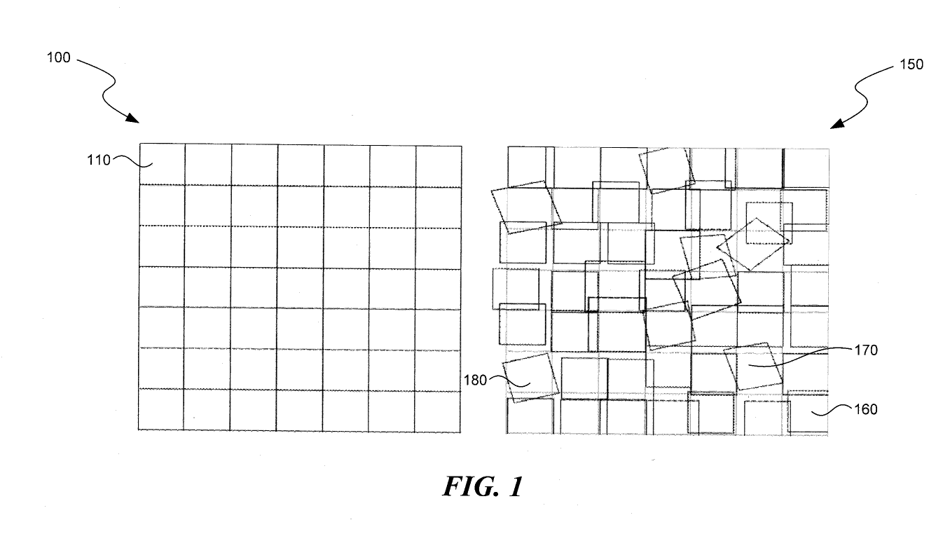

FIG. 1 illustrates a reference frame and a warp frame in one embodiment. The four-corner motion system has divided the reference frame 100 into blocks 110. The warp frame 150 shows the position of the blocks 110 in a subsequent frame. As shown in the figure, the blocks have moved to various positions based on the motion of the objects depicted in the frame. For example, some blocks have merely moved translationally 160, while other blocks have sheared 170 or rotated 180. Instead of simply describing the motion of each block at a translational level, the four-corner motion system describes the motion of each block based on the movement of each corner of the block. This model more precisely represents the motion of blocks that shear, rotate, or undergo other nontranslational movements.

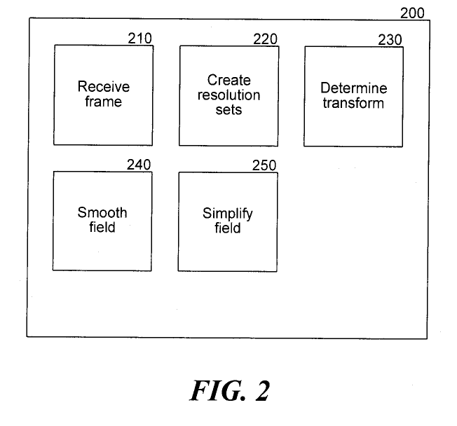

FIG. 2 is a block diagram that illustrates components of the four-corner motion system in one embodiment. The four-corner motion system 200 contains a receive frame component 210, a create resolution sets component 220, a determine transform component 230, a smooth field component 240, and a simplify field component 250. The receive frame component 210 receives the reference and warp frames that will be used to determine the motion field. The create resolution sets component 220 optionally creates pairs of images representing lower resolution sets of the received reference and warp frame. This process is described further in the Pyramid Optimization section herein. The determine transform component 230 selects a transform for each block of the reference frame. The determine transform component 230 may perform several rounds of selecting a transform, testing the fit of the transform to the warp frame, and selecting a better transform until an appropriate fit is found. Techniques for testing the fit of a transform are described in the Determining Transforms section herein. The smooth field component 240 improves the smoothness of the motion field by relating the transform for each block to that of the neighboring blocks. In some instances, a neighboring block may contain a transform that provides a better fit for a particular block, and the four-corner motion system may replace the transform initially selected for the block with the transform of the neighboring block. The simplify field component 250 reduces the complexity of transforms for blocks that do not undergo complex motion. For example, for a block that only moves translationally or has only small complex movements, the four-corner motion system may degrade the transform neatly into a simpler affine transform to reduce the computational complexity of modeling based on the motion field.

The computing device on which the system is implemented may include a central processing unit, graphics processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

### Determining Transforms

The four-corner motion system may go through several phases to determine the most appropriate transform for each block of the reference frame. For example, the four-corner motion system may select an initial transform for each block using an eight-parameter gradient-descent algorithm based on the movement of each of the four corners of the block. The gradient-descent algorithm refines the transform by minimizing the displaced frame difference (DFD). The four-corner motion system calculates the DFD by computing the sum of the squares of the grayscale pixel differences between the warp region to which a block moves and the block in the reference frame. After determining a transform for each block, the four-corner motion system may perform one or more smoothing and simplification phases. During the smoothing phases, the four-corner motion system may replace or refine the transform for each block based on information about the transforms of neighboring blocks. During the simplification process, the four-corner motion system may replace the transforms of blocks that only undergo simple movements with simpler transforms.

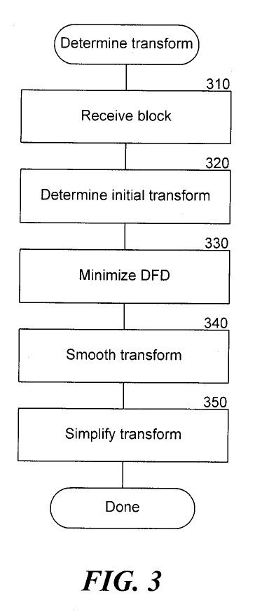

FIG. 3 is a flow diagram that illustrates the processing performed by the determine transform component in one embodiment. In block 310, the component receives a block in the reference frame for which the component will determine a transform to describe the motion of the block in the warp frame. In block 320, the component determines an initial transform for the block. For example, the component may copy an initial transform from a neighboring block or from a lower resolution set (described further herein). The component may also determine an initial transform based on the change in coordinates of the four corners of the block. In block 330, the component refines the transform by minimizing the DFD. In block 340, the component performs one or more smoothing phases to smooth the transform of one block with relation to the transforms of the neighboring blocks. The four-corner motion system may wait to perform this step until after an initial transform has been determined for each block. Alternatively, the four-corner motion system may perform smoothing at various points, such as whenever the transform for a block changes. In block 350, the component simplifies the transform by determining whether the movement of the four corners is a simple translational movement and, if so, degrading the transform into a simpler model. After block 350, these steps conclude.

In some embodiments, the four-corner motion system determines whether one transform is an improvement over another using two weighted error components. The first component is the DFD described above. The second component is the sum of the differences between the transform and each of the transforms of the neighboring blocks. A high difference between neighboring transforms implies the motion is not smooth. In some embodiments, the weighting between the two error components is user-configurable. Although smooth motion is usually preferable, in some applications the user may want to select a different weighting to model motion in different ways.

In some embodiments, the four-corner motion system determines the motion field at a pixel level. After the motion field is determined at the block level as described above, the four-corner motion system determines the model for each pixel. The four-corner motion system represents each pixel motion by a translational offset derived from the four-corner transforms near it. For each pixel, there are usually nine blocks to choose from—the one containing the pixel and eight neighboring blocks. Each of these transforms would warp the current pixel in a different direction, leading to nine different possibilities for the pixel motion.

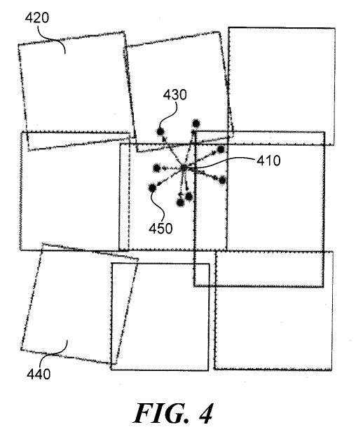

FIG. 4 illustrates the effect of each of nine transforms on the motion of a pixel in one embodiment. The transform of each block affects the pixel 410 differently. For example, applying the transform of block 420 would place the pixel at location 430. Applying the transform of block 440 would place the pixel at location 450. The four-corner motion system measures each possibility in turn by evaluating the pixel DFD. The pixel DFD is the square of the difference between the grayscale pixel values at the pixel site 410 and at the offset bilinearly interpolated site in the warp image.

In some embodiments, the four-corner motion system performs smoothing for each pixel. After assigning a motion to each pixel, the four-corner motion system may smooth the motion field in one or more passes (e.g., five) similar to the smoothing passes performed for the blocks. The four-corner motion system chooses a new motion value from each of the pixel's neighbors until the system finds a motion value that produces the least error. The error of each candidate motion value is the weighted sum of the pixel DFD and the pixel smoothness. The pixel smoothness is the sum of the squares of the vector differences between the chosen motion value and all the neighboring values. Once the last smoothing phase is complete, the calculation of the motion field is complete, and each pixel motion is derived from a hierarchy of four-corner transforms.

### Motion Field Simplification

An appropriate motion field with a high degree of accuracy can be determined using the methods described herein. In some cases, the accuracy is higher than what is required for the particular application, and the four-corner motion system may perform a simplification phase to reduce the complexity of the motion field.

In some embodiments, the four-corner motion system degrades the degree of the transform into either simpler affine transforms or rotational and translational transforms. For example, when a block only moves translationally, the four-corner motion system may represent the motion using a simple x-y coordinate transform (two parameters) rather than describing the movement of each of the four corners (eight parameters). As another example, if the block rotates, then the four-corner motion system may represent the motion using a rotational parameter.

### Pyramid Optimization

As described, the technique works best for small motions. In some embodiments, the four-corner motion system uses a multi-resolution approach to be successful with a wider range of motions. For example, for each reference and warp image, the four-corner motion system produces a series of successively smaller proxy images (e.g., each half the resolution of the one before). The four-corner motion system stops the generation of this pyramid of images when the smallest image is still big enough to contain a threshold number (e.g., six) of transform blocks along its major dimension. The four-corner motion system then performs the described block technique first at the smallest resolution. After the smoothing phase has been run five times, the discovered block transforms are used to initialize the set of blocks for the next higher-resolution image pair by duplicating each block into the four blocks immediately above it in the image pyramid. The blocks at the next resolution are then already initialized into approximately the right position before the next gradient-descent phase. The four-corner motion system continues the multi-resolution process until the blocks at the highest resolution have been smoothed.

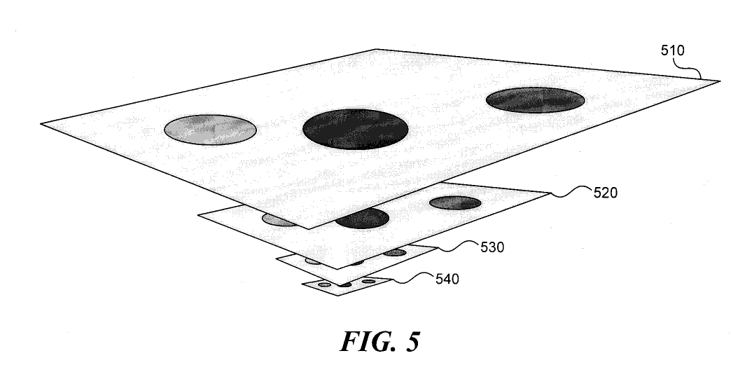

FIG. 5 illustrates the pyramid of images created by the pyramid optimization process in one embodiment. The initial image 510 has a high resolution and may be composed of many pixels. The next image 520 has a lower resolution (e.g., half) and contains fewer pixels and thus fewer blocks. The next images 530 and 540 have even lower resolutions. By performing the block-based techniques described herein for determining a transform for each block on the lowest resolution image 540 first, the four-corner motion system can ensure that the largest motions will have the greatest effect on the motion field. Smaller motions will not be as pronounced in the lowest resolution images, yet large motions will still be recognizable. Thus, the pyramid optimization produces an improved motion field for larger motions.

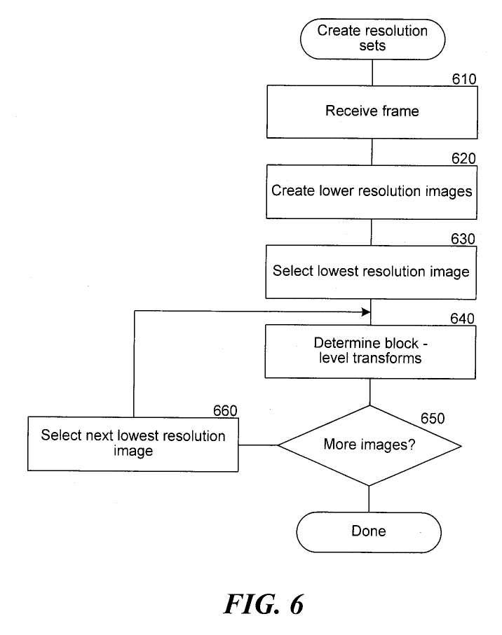

FIG. 6 is a flow diagram that illustrates the pyramid optimization performed by the create resolution sets component of the four-corner motion system in one embodiment. In block 610, the component receives the reference frame. In block 620, the component creates a set of successively lower resolution images based on the received frame. For example, each image may be half the resolution of the previous image. The component stops upon reaching a certain threshold, such as when the lowest resolution image contains a minimum number of blocks. In block 630, the component selects the lowest resolution image. In block 640, the component determines transforms for each of the blocks in the selected image. If the component has performed a previous round on a lower resolution image, then the component initially assigns to each block a transform from a corresponding block in the lower resolution image. In decision block 650, if there are more images, then the component continues at block 660, else the component completes. In block 660, the component selects the next lowest resolution image and loops to block 640 to determine block-level transforms for the image.

### CONCLUSION

From the foregoing, it will be appreciated that specific embodiments of the four-corner motion system have been described herein for purposes of illustration, but that various modifications may be made without deviating from the spirit and scope of the invention. Accordingly, the invention is not limited except as by the appended claims.

I/We claim:

1. A computer-readable medium containing instructions for controlling a computer system to produce a warp frame using a vector field based on a reference frame through a multi-resolution approach, by a method comprising:
producing a series of lower resolution images for each of the reference frame and warp frame, wherein the reference frame image and warp frame image at each resolution form an image pair;
for each image pair, starting at the image pair having the lowest resolution,
identifying a motion field of four-corner transforms that maps areas of the warp image of the pair to each block of the reference image of the pair;
initializing the set of blocks for the next higher-resolution image pair by duplicating the identified transform of each block of the lower resolution image pair into the blocks of the next higher-resolution image pair that contain the block of the lower resolution image pair; and
after identifying the motion field for the highest resolution image pair, storing the motion field in a nonvolatile memory.

2. The computer-readable medium of claim 1, further comprising, for each image pair, performing one or more smoothing phases to refine the identified motion field based on the transforms of neighboring blocks.

3. A system for determining a motion field that describes the movement of objects in a reference frame, the system comprising:
a receive frame component configured to receive the reference frame and a warp frame used to determine the motion field;
a determine transform component configured to select a transform for each block of the reference frame, wherein the transform is based on the motion of each of four corners of the block between the reference frame and warp frame; and
a smooth field component configured to improve the smoothness of the motion field by relating the transform for each block to that of neighboring blocks.

4. The system of claim 3, further comprising a create resolution sets component configured to create pairs of images representing lower resolution sets of the received reference and warp frames, wherein the determine transform component determines transforms for each of the resolution sets.

5. The system of claim 3 wherein the determine transform component performs several rounds of selecting a transform, testing the fit of the transform to the warp frame, and selecting a better transform until an appropriate fit is found.

6. The system of claim 3 wherein the smooth field component replaces the transform of a block with that of the neighboring block when the transform of the neighboring block produces a lower error value according to a weighted error determination.

7. The system of claim 3 including a simplify field component configured to reduce the complexity of the motion field by simplifying the transforms of blocks that do not undergo complex motion.

8. A method in a computer system for producing a warp frame using a vector field based on a reference frame, the method comprising:
dividing the reference frame into a grid of reference blocks; and
for each reference block, identifying a four-corner transform that maps a four-sided region of the warp frame to the reference block, wherein the transform is based on the position of each of the four corners of the reference block in the region of the warp frame.

9. The method of claim 8 wherein each block in the grid of blocks comprises a fixed number of pixels.

10. The method of claim 8 wherein each identified four-corner transform is represented by a two-dimensional offset at each corner of the four-sided region of the warp frame.

11. The method of claim 8 wherein identifying a four-corner transform comprises performing a gradient-descent algorithm to minimize the displaced frame distance between the region of the warp frame and the reference block.

12. The method of claim 11 wherein the displaced frame distance is determined by determining the sum of the squares of the grayscale pixel differences between the region of the warp frame and the reference block.

13. The method of claim 8, further comprising, after an initial transform is identified for each reference block, smoothing the vector field by replacing at least one initial transform with an alternate transform.

14. The method of claim 13 wherein smoothing comprises replacing the initial transform associated with a particular reference block with the initial transform associated with a neighboring reference block.

15. The method of claim 13 wherein smoothing comprises determining whether the alternate transform is a better fit than the initial transform based on an error calculation.

16. The method of claim 15 wherein the error calculation comprises determining the sum of a first weighted error component comprising a displaced frame distance and a second weighted error component comprising a sum of the differences between the transform and each neighboring transform.

17. The method of claim 16 wherein the weighting of the error components is tunable by a user.

18. The method of claim 15 wherein the error calculation indicates a smoothness of motion between the reference block and the warp region.

19. The method of claim 15 wherein the error calculation comprises measuring the sum of the squared vector differences of each of the four corners of the reference block.

20. The method of claim 8, further comprising creating a lower resolution proxy of the reference frame and a lower resolution proxy of the warp frame.
